(19) United States
(12) Patent Application Publication
(10) Pub. No.: US 2022/0050228 A1
(43) Pub. Date: Feb. 17, 2022

(54) PRESSURE-SENSITIVE ADHESIVE LAYER-INCLUDING TRANSPARENT ELECTRICALLY CONDUCTIVE SHEET, TOUCH SENSOR, AND IMAGE DISPLAY DEVICE

(71) Applicant: NITTO DENKO CORPORATION, Ibaraki-shi, Osaka (JP)

(72) Inventor: Takanobu Yano, Osaka (JP)

(73) Assignee: NITTO DENKO CORPORATION, Ibaraki-shi, Osaka (JP)

(21) Appl. No.: 17/269,384

(22) PCT Filed: Aug. 12, 2020
(86) PCT No.: PCT/JP2020/030704

§ 371 Date: Feb. 18, 2021

(30) Foreign Application Priority Data
Aug. 21, 2019 (JP) 2019-151035
Jul. 21, 2020 (JP) 2020-124417

(51) Int. Cl. G02B 1/14; G06F 3/041

(52) U.S. Cl. CPC G02B 1/14; G06F 2203/04102; G06F 3/041

(57) ABSTRACT

A pressure-sensitive adhesive layer-including transparent electrically conductive sheet 2 includes a first pressure-sensitive adhesive layer 3, a hard coat layer 4 disposed on a one surface 32 in a thickness direction of the first pressure-sensitive adhesive layer 3, a transparent electrically conductive layer 5 disposed on a one surface 42 in the thickness direction of the hard coat layer 4, and a second pressure-sensitive adhesive layer 6 disposed on the one surface 42 in the thickness direction of the hard coat layer 4 so as to cover the transparent electrically conductive layer 5. In a first direction, each of both edge surfaces 43 of the hard coat layer 4 is disposed inside with respect to each of both edge surfaces 33 of the first pressure-sensitive adhesive layer 3, and is disposed inside with respect to each of both edge surfaces 63 of the second pressure-sensitive adhesive layer 6.

### TECHNICAL FIELD

The present invention relates to a pressure-sensitive adhesive layer-including transparent electrically conductive sheet, a touch sensor, and an image display device.

### BACKGROUND ART

Conventionally, a touch sensor laminate including an adhesive layer, a separation layer, an electrode pattern layer, and a pressure-sensitive adhesive layer in order in a thickness direction has been proposed (ref: for example, Patent Document 1 below).

In Patent Document 1, each of both edge surfaces of the pressure-sensitive adhesive layer, each of both edge surfaces of the separation layer, and each of both edge surfaces of the adhesive layer coincide with each other when projected in the thickness direction. The touch sensor laminate usually has a first edge surface connecting one ends of both edge surfaces described above to each other, and a second edge surface connecting the other ends of both edge surfaces described above to each other.

### CITATION LIST

### Patent Document

Patent Document 1: Japanese Unexamined Patent Publication No. 2019-3653

### SUMMARY OF THE INVENTION

### Problem to be Solved by the Invention

However, there is a case where the touch sensor laminate is deflected so that the first edge surface and the second edge surface get close to each other in accordance with the application and the purpose of the touch sensor laminate. In that case, the stress is easily concentrated on both edge surfaces of the separation layer, and there is a problem that the separation layer is easily damaged due to this.

The present invention provides a pressure-sensitive adhesive layer-including transparent electrically conductive sheet that can suppress damage to both edge surfaces of a hard coat layer, a touch sensor, and an image display device.

### Means for Solving the Problem

The present invention (1) includes a pressure-sensitive adhesive layer-including transparent electrically conductive sheet including a first pressure-sensitive adhesive layer, a hard coat layer disposed on one surface in a thickness direction of the first pressure-sensitive adhesive layer, a transparent electrically conductive layer disposed on one surface in the thickness direction of the hard coat layer, and a second pressure-sensitive adhesive layer disposed on one surface in the thickness direction of the hard coat layer so as to cover the transparent electrically conductive layer, wherein in a first direction perpendicular to the thickness direction, each of both edge surfaces of the hard coat layer is disposed inside with respect to each of both edge surfaces of the first pressure-sensitive adhesive layer, and is disposed inside with respect to each of both edge surfaces of the second pressure-sensitive adhesive layer.

In the pressure-sensitive adhesive layer-including transparent electrically conductive sheet, even when the hard coat layer is deflected and the stress is concentrated on both edge surfaces of the hard coat layer so that a first edge surface connecting one ends in a second direction perpendicular to the thickness direction and the first direction, and a second edge surface connecting the other ends in the second direction of both edge surfaces of the hard coat layer get close to each other, the first pressure-sensitive adhesive layer and the second pressure-sensitive adhesive layer near the outside of both edge surfaces of the hard coat layer can disperse the stress. Therefore, it is possible to suppress damage to both edge surfaces of the hard coat layer.

The present invention (2) includes the pressure-sensitive adhesive layer-including transparent electrically conductive sheet described in (1), wherein the second pressure-sensitive adhesive layer is in contact with both edge surfaces of the hard coat layer in the first direction.

In the pressure-sensitive adhesive layer-including transparent electrically conductive sheet, since the second pressure-sensitive adhesive layer is in contact with both edge surfaces of the hard coat layer in the first direction, it is possible to effectively suppress damage to both edge surfaces of the hard coat layer.

The present invention (3) includes the pressure-sensitive adhesive layer-including transparent electrically conductive sheet described in (1) or (2), wherein the pressure-sensitive adhesive layer-including transparent electrically conductive sheet is bendable so that both end portions in the thickness direction and a second direction get close to each other.

Since the pressure-sensitive adhesive layer-including transparent electrically conductive sheet is bendable, it has excellent handleability. Moreover, since the pressure-sensitive adhesive layer-including transparent electrically conductive sheet is bendable so that both end portions in the second direction get close to each other, even when the pressure-sensitive adhesive layer-including transparent electrically conductive sheet is bent so that both end portions in the second direction get close to each other, the first pressure-sensitive adhesive layer and the second pressure-sensitive adhesive layer near the outside of both edge surfaces of the hard coat layer can disperse the stress. Therefore, the pressure-sensitive adhesive layer-including transparent electrically conductive sheet has excellent handleability and excellent reliability.

The present invention (4) includes a touch sensor including the pressure-sensitive adhesive layer-including transparent electrically conductive sheet described in any one of (1) to (3) and an optical member disposed on one surface in a thickness direction of the pressure-sensitive adhesive layer-including transparent electrically conductive sheet.

The touch sensor can suppress damage to both edge surfaces of the hard coat layer.

The present invention (5) includes an image display device including the touch sensor described in (4) and an image display member disposed on the other surface in a thickness direction of the touch sensor.

The image display device can suppress damage to both edge surfaces of the hard coat layer.

### Effect of the Invention

The pressure-sensitive adhesive layer-including transparent electrically conductive sheet, the touch sensor, and the image display device of the present invention can suppress damage to both edge surfaces of a hard coat layer.

### BRIEF DESCRIPTION OF THE DRAWINGS

FIG. 1 shows a plan view of one embodiment of a touch sensor of the present invention.

FIG. 2 shows a cross-sectional view along an X-X line of the touch sensor shown in FIG. 1.

FIGS. 3A to 3B show production steps of the touch sensor shown in FIG. 2;

FIG. 3A illustrating a step of preparing an optical laminate, and a hard coat layer and a transparent electrically conductive layer supported by a support peeling laminate and

FIG. 3B illustrating a step of attaching the optical laminate to the hard coat layer and the transparent electrically conductive layer.

FIGS. 4A to 4B show production steps of an image display device:

FIG. 4A illustrating a step of preparing a hard coat layer, a transparent electrically conductive layer, and a second pressure-sensitive adhesive layer from which a support peeling laminate is peeled, an optical member, and an image display member and

FIG. 4B illustrating a step of attaching the image display member to the hard coat layer through a first pressure-sensitive adhesive layer.

FIG. 5 shows a cross-sectional view of a modified example (embodiment in which a recessed portion is formed in both end portions of a pressure-sensitive adhesive layer-including transparent electrically conductive sheet) of the touch sensor shown in FIG. 2.

FIG. 6 shows a cross-sectional view of a modified example (embodiment in which a recessed portion is formed in both end portions of a pressure-sensitive adhesive layer-including transparent electrically conductive sheet) of the image display device shown in FIG. 4B.

FIG. 7 shows a plan view of a pressure-sensitive adhesive layer-including transparent electrically conductive sheet to which an electrically conductive tape is attached in Examples and Comparative Example.

FIGS. 8A to 8C show process cross-sectional views along a first direction of a pressure-sensitive adhesive layer-including transparent electrically conductive sheet of Example:

FIG. 8A illustrating a hard coat layer supported by a support peeling laminate, a transparent electrically conductive layer, and a second pressure-sensitive adhesive layer supported by a second peeing layer,

FIG. 8B illustrating a support substrate-including laminate, and

FIG. 8C illustrating the pressure-sensitive adhesive layer-including transparent electrically conductive sheet.

FIGS. 9A to 9C show process cross-sectional views along a second direction of a pressure-sensitive adhesive layer-including transparent electrically conductive sheet of Example:

FIG. 9A illustrating a hard coat layer supported by a support peeling laminate, a transparent electrically conductive layer, and a second pressure-sensitive adhesive layer supported by a second peeing layer,

FIG. 9B illustrating a support substrate-including laminate, and

FIG. 9C illustrating the pressure-sensitive adhesive layer-including transparent electrically conductive sheet.

FIGS. 10A to 10C show process cross-sectional views along a first direction of a pressure-sensitive adhesive layer-including transparent electrically conductive sheet of Comparative Example:

FIG. 10A illustrating a hard coat layer supported by a support peeling laminate, a transparent electrically conductive layer, and a second pressure-sensitive adhesive layer supported by a second peeing layer.

FIG. 10B illustrating a support substrate-including laminate, and

FIG. 10C illustrating a pressure-sensitive adhesive layer-including transparent electrically conductive sheet.

FIG. 11 shows a cross-sectional view of a pressure-sensitive adhesive layer-including transparent electrically conductive sheet after bending.

### DESCRIPTION OF EMBODIMENTS

### One Embodiment

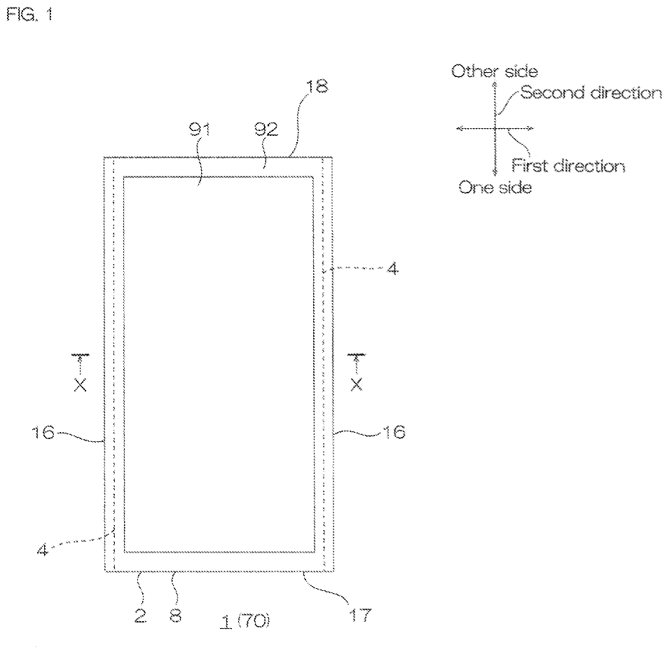

One embodiment of a pressure-sensitive adhesive layer-including transparent electrically conductive sheet and a touch sensor of the present invention is described with reference to FIGS. 1 to 4B.

In FIG. 1, the outer shape of a hard coat layer 4 (described later) is shown by both a hidden line and a solid line. In FIGS. 1 to 4B, a thickness, a length, and the like are appropriately exaggerated to clearly show the layer configuration and the positional relation.

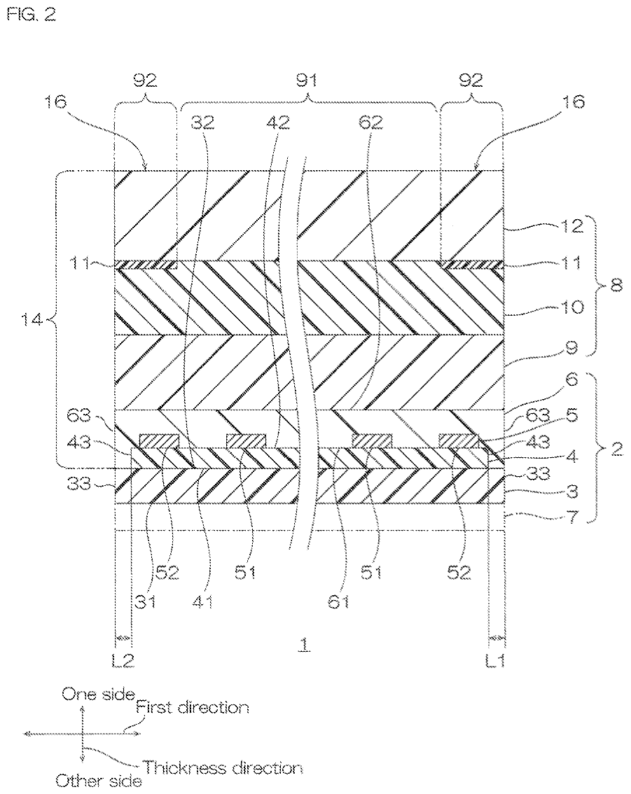

As shown in FIGS. 1 to 2, a touch sensor 1 has a shape extending in a plane direction perpendicular to a thickness direction. The plane direction includes a first direction and a second direction perpendicular thereto. The touch sensor 1 has, for example, a generally rectangular shape when viewed from the top (synonymous with a projected surface when projected in the thickness direction). The touch sensor 1 integrally includes both end portions 16 spaced apart from each other in the first direction, a first end portion 17 connecting one end portions in the second direction of both end portions 16 to each other, and a second end portion 18 connecting the other end portions in the second direction of both end portions 16 to each other. Both end portions 16, the first end portion 17, and the second end portion 18 constitute a margin region 92 to be described later. The touch sensor 1 is bendable so that the first end portion 17 and the second end portion 18 get close to each other. When the touch sensor 1 is bent as described above, a bending line is along the first direction.

The touch sensor 1 includes a pressure-sensitive adhesive layer-including transparent electrically conductive sheet 2 and an optical member 8. A shape of the pressure-sensitive adhesive layer-including transparent electrically conductive sheet 2 when viewed from the top is the same as that of the touch sensor 1. That is, the pressure-sensitive adhesive layer-including transparent electrically conductive sheet 2 has a generally flat plate shape extending in the plane direction. The pressure-sensitive adhesive layer-including transparent electrically conductive sheet 2 includes a first pressure-sensitive adhesive layer 3, the hard coat layer 4, a transparent electrically conductive layer 5, and a second pressure-sensitive adhesive layer 6. Further, the touch sensor 1 further includes a peeling layer 7 shown by a phantom line.

The first pressure-sensitive adhesive layer 3 is a first pressure-sensitive adhesion layer. The first pressure-sensitive adhesive layer 3 has a generally flat plate shape extending in the plane direction. Specifically, the first pressure-sensitive adhesive layer 3 has a generally rectangular shape when viewed in the cross-sectional view. The first pressure-sensitive adhesive layer 3 includes an other surface 31 in the thickness direction, a one surface 32 in the thickness direction disposed at one side in the thickness direction of the other surface 31, and both edge surfaces 33 connecting one end edge in the first direction of the other surface 31 to one end edge in the first direction of the one surface 32, and connecting the other end edge in the first direction of the other surface 31 to the other end edge in the first direction of the one surface 32. The other surface 31 and the one surface 32 of the first pressure-sensitive adhesive layer 3 are parallel. Both of the other surface 31 and the one surface 32 of the first pressure-sensitive adhesive layer 3 are flat surfaces along the plane direction. Both edge surfaces 33 of the first pressure-sensitive adhesive layer 3 are both outer-side surfaces in the first direction. Both edge surfaces 33 are disposed in both end portions 16 in the touch sensor 1 rather than the first end portion 17 and the second end portion 18 in the touch sensor 1. Both edge surfaces 33 of the first pressure-sensitive adhesive layer 3 extend in the thickness direction. A material for the first pressure-sensitive adhesive layer 3 is not particularly limited, and examples thereof include pressure-sensitive adhesives (pressure-sensitive adhesion agents) such as an acrylic pressure-sensitive adhesive, an epoxy-based pressure-sensitive adhesive, a silicone-based pressure-sensitive adhesive, and a urethane-based pressure-sensitive adhesive.

The tensile elastic modulus E at 25° C. of the first pressure-sensitive adhesive layer 3 is, for example, 0.05 MPa or more, preferably 0.10 MPa or more, and for example, 50 MPa or less, preferably 1 MPa or less. When the tensile elastic modulus E of the first pressure-sensitive adhesive layer 3 is the above-described lower limit or more and the above-described upper limit or less, it is possible to effectively suppress damage to both edge surfaces 43 of the hard coat layer 4. A measurement method of the tensile elastic modulus E is described in Examples later. Further, the measurement method of the tensile elastic modulus E of the second pressure-sensitive adhesive layer 6 is the same as the description above.

The shear storage elastic modulus G′ at 25° C. of the first pressure-sensitive adhesive layer 3 is, for example, 0.02 MPa or more, preferably 0.04 MPa or more, and for example, 5 MPa or less, preferably 0.4 MPa or less. When the shear storage elastic modulus G′ of the first pressure-sensitive adhesive layer 3 is the above-described lower limit or more and the above-described upper limit or less, it is possible to effectively suppress damage to both edge surfaces 43 of the hard coat layer 4. A measurement method of the shear storage elastic modulus G′ is described in Examples later. Further, the measurement method of the shear storage elastic modulus G′ of the second pressure-sensitive adhesive layer 6 is the same as the description above.

The total light transmittance of the first pressure-sensitive adhesive layer 3 is, for example, 80% or more, preferably 85% or more, more preferably 90% or more, and for example, 100% or less. A thickness of the first pressure-sensitive adhesive layer 3 is, for example, 1 μm or more, preferably 5 μm or more, and for example, 50 μm or less, preferably 25 μm or less.

The hard coat layer 4 is a backing layer that protects and supports the transparent electrically conductive layer 5 to be described next from the other side in the thickness direction. The hard coat layer 4 is disposed on the one surface 32 of the first pressure-sensitive adhesive layer 3. Specifically, the hard coat layer 4 is in contact with a region inside both edge surfaces 33 in the first direction on the one surface 32 in the thickness direction of the first pressure-sensitive adhesive layer 3. The hard coat layer 4 has a generally flat plate shape extending in the plane direction. The hard coat layer 4 has a generally rectangular shape when viewed in the cross-sectional view. The hard coat layer 4 includes an other surface 41 in the thickness direction, a one surface 42 disposed at one side in the thickness direction of the other surface 41, and both edge surfaces 43 connecting one end edge in the first direction of the other surface 41 to one end edge in the first direction of the one surface 42, and connecting the other end edge in the first direction of the other surface 41 to the other end edge in the first direction of the one surface 42. The other surface 41 of the hard coat layer 4 is in contact with a region inside both edge surfaces 33 in the first direction on the one surface 32 of the first pressure-sensitive adhesive layer 3. The one surface 42 of the hard coat layer 4 is a flat surface parallel to the one surface 32 of the first pressure-sensitive adhesive layer 3. Both edge surfaces 43 of the hard coat layer 4 are outer-side surfaces in the first direction. The one surface 42 of the hard coat layer 4 is disposed in both end portions 16 in the touch sensor 1 rather than the first end portion 17 and the second end portion 18 in the touch sensor 1. Each of both edge surfaces 43 of the hard coat layer 4 is disposed inside from each of both edge surfaces 33 of the first pressure-sensitive adhesive layer 3 in the first direction.

An example of a material for the hard coat layer 4 includes a transparent composition (hard coat composition) containing a transparent resin such as an acrylic resin (including a urethane acrylate). The details of the resin composition are, for example, described in Japanese Unexamined Patent Publication No. 2019-31041.

The tensile elastic modulus E at 25° C. of the hard coat layer 4 is, for example, 0.1 GPa or more, preferably 1 GPa or more, and for example, 4 GPa or less, preferably 3 GPa or less. When the tensile elastic modulus E of the hard coat layer 4 is the above-described lower limit or more, the transparent electrically conductive layer 5 can be reliably reinforced. When the tensile elastic modulus E of the hard coat layer 4 is the above-described upper limit or less, it is possible to suppress the overall damage to the hard coat layer 4.

In the first direction, a distance L1 between each of both edge surfaces 43 of the hard coat layer 4 and each of both edge surfaces 33 of the first pressure-sensitive adhesive layer 3 is, for example, 0.1 mm or more, preferably 0.2 mm or more, and for example, 0.5 mm or less. When the distance L1 is the above-described lower limit or more, it is possible to effectively suppress damage to both edge surfaces 43 of the hard coat layer 4. When the distance L1 is the above-described upper limit or less, the area of the hard coat layer 4 with respect to the area of the first pressure-sensitive adhesive layer 3 can be increased, and therefore, a ratio of the arrangement area of the transparent electrically conductive layer 5 disposed on the one surface 42 of the hard coat layer 4 in the unit area of the touch sensor 1 can be increased.

A thickness of the hard coat layer 4 is, for example, 0.5 μm or more, preferably 2 μm or more, and for example, 10 μm or less, preferably 5 μm or less. A ratio of the thickness of the first pressure-sensitive adhesive layer 3 to the thickness of the hard coat layer 4 is, for example, 0.1 or more, preferably 1 or more, and for example, 50 or less, preferably 10 or less. When the thickness and/or the ratio of the hard coat layer 4 are/is the above-described lower limit or more, it is possible to effectively suppress damage to both edge surfaces 43 of the hard coat layer 4. When the thickness and/or the ratio of the hard coat layer 4 are/is the above-described upper limit or less, a ratio of the arrangement area of the transparent electrically conductive layer 5 disposed on the one surface 42 of the hard coat layer 4 in the unit area of the touch sensor 1 can be increased.

The transparent electrically conductive layer 5 is disposed on one surface in the thickness direction of the hard coat layer 4. The transparent electrically conductive layer 5 includes a transparent electrode 51 and a routing wire 52. The transparent electrode 51 is in contact with a display region 91 located inside both end portions 16, the first end portion 17, and the second end portion 18 on the one surface 42 of the hard coat layer 4. In other words, the transparent electrode 51 constitutes the display region 91 in the transparent electrically conductive layer 5. The transparent electrodes 51 are disposed at spaced intervals to each other in the plane direction. The routing wire 52 is continuous to the end portion of the transparent electrode 51 (not shown), and is in contact with the margin region 92 located in both end portions 16, the first end portion 17, and the second end portion 18 on one surface in the thickness direction of the hard coat layer 4. The routing wire 52 constitutes the margin region 92 in the transparent electrically conductive layer 5. The margin region 92 includes (is overlapped with) both edge surfaces 43 of the hard coat layer 4 when viewed from the top. Each of the transparent electrode SI and the routing wire 52 has a generally rectangular shape when viewed in the cross-sectional view. A metal layer which is not shown may be also provided on one surface in the thickness direction of the routing wire 52.

Examples of a material for the transparent electrically conductive layer 5 include metal oxides, and preferably, indium-containing oxides such as an indium-tin composite oxide (ITO) are used. The surface resistance of the transparent electrically conductive layer 5 is, for example, 150Ω/□ or less, and for example, 1Ω/□ or more. The total light transmittance of the transparent electrically conductive layer 5 is, for example, 80% or more, preferably 85% or more, more preferably 90% or more, and for example, 100% or less. A thickness of the transparent electrically conductive layer 5 is, for example, 10 nm or more, and for example, 200 nm or less, preferably 100 nm or less, more preferably 75 nm or less.

The second pressure-sensitive adhesive layer 6 is a second pressure-sensitive adhesion layer. The second pressure-sensitive adhesive layer 6 covers the hard coat layer 4 and the transparent electrically conductive layer 5. The second pressure-sensitive adhesive layer 6 extends in the plane direction. The second pressure-sensitive adhesive layer 6 includes an other surface 61 in the thickness direction, a one surface 62 in the thickness direction disposed at one side in the thickness direction of the other surface 61, and both edge surfaces 63 connecting one end edge in the first direction of the other surface 61 to one end edge in the first direction of the one surface 62, and connecting the other end edge in the first direction of the other surface 61 to the other end edge in the first direction of the one surface 62.

The other surface 61 of the second pressure-sensitive adhesive layer 6 has a shape that follows the shape of the hard coat layer 4 and the transparent electrically conductive layer 5. Specifically, the other surface 61 is in contact with one surface in the thickness direction of the transparent electrically conductive layer 5, the side surfaces of the transparent electrically conductive layer 5, the one surface 42 of the hard coat layer 4 around the transparent electrically conductive layer 5, both edge surfaces 43 of the hard coat layer 4, and the one surface 32 of the first pressure-sensitive adhesive layer 3 around the hard coat layer 4.

The one surface 62 of the second pressure-sensitive adhesive layer 6 is a flat surface parallel to the one surface 42 of the hard coat layer 4.

Both edge surfaces 63 of the second pressure-sensitive adhesive layer 6 are both side surfaces in the first direction. Both edge surfaces 63 of the second pressure-sensitive adhesive layer 6 are disposed in both end portions 16 in the touch sensor 1 rather than the first end portion 17 and the second end portion 18 in the touch sensor 1. Both edge surfaces 63 of the second pressure-sensitive adhesive layer 6 are exposed toward both outer sides in the first direction. Each of both edge surfaces 63 of the second pressure-sensitive adhesive layer 6 coincides with each of both edge surfaces 33 of the first pressure-sensitive adhesive layer 3. Therefore, each of both edge surfaces 63 of the second pressure-sensitive adhesive layer 6 is disposed outside with respect to each of both edge surfaces 43 of the hard coat layer 4. In other words, each of both edge surfaces 43 of the hard coat layer 4 is disposed inside with respect to each of both edge surfaces 63 of the second pressure-sensitive adhesive layer 6.

A material, the tensile elastic modulus E, the shear storage elastic modulus G′, the total light transmittance, a thickness, and the like of the second pressure-sensitive adhesive layer 6 are the same as those of the first pressure-sensitive adhesive layer 3. A ratio of the thickness of the second pressure-sensitive adhesive layer 6 to the thickness of the hard coat layer 4 is, for example, 0.1 or more, preferably 1 or more, and for example, 50 or less, preferably 10 or less. A ratio of the total thickness of the first pressure-sensitive adhesive layer 3 and the second pressure-sensitive adhesive layer 6 to the thickness of the hard coat layer 4 is, for example, 0.1 or more, preferably 1 or more, and for example, 100 or less, preferably 20 or less. A ratio of the thickness of the second pressure-sensitive adhesive layer 6 to the thickness of the first pressure-sensitive adhesive layer 3 is, for example, 0.1 or more, preferably 0.3 or more, and for example, 10 or less, preferably 3 or less. When the thickness and/or the ratio described above are/is within the above-described range, it is possible to effectively suppress damage to both edge surfaces 43 of the hard coat layer 4. The thickness of the second pressure-sensitive adhesive layer 6 is a distance between the one surface 62 of the second pressure-sensitive adhesive layer 6 and the one surface 42 of the hard coat layer 4.

In the first direction, a distance L2 between each of both edge surfaces 63 of the second pressure-sensitive adhesive layer 6 and each of both edge surfaces 43 of the hard coat layer 4 is the same as the distance L1 described above. When the distance L2 is the above-described lower limit or more, it is possible to effectively suppress damage to both edge surfaces 43 of the hard coat layer 4. When the distance L2 is the above-described upper limit or less, even in a case where the second pressure-sensitive adhesive layer 6 is formed by application (described later) or the like with respect to the hard coat layer 4, each of both edge surfaces 63 of the second pressure-sensitive adhesive layer 6 can be reliably disposed outside with respect to each of both edge surfaces 43 of the hard coat layer 4.

The peeling layer 7 shown by a phantom line of FIG. 2 is disposed on the other surface 31 of the second pressure-sensitive adhesive layer 6. Specifically, the peeling layer 7 is in contact with the entire other surface 31 of the second pressure-sensitive adhesive layer 6. An example of the peeling layer 7 includes a known peeling liner.

A thickness of the pressure-sensitive adhesive layer-including transparent electrically conductive sheet 2 is, for example, 3 μm or more, preferably 10 μm or more, and for example, 100 μm or less, preferably 50 μm or less.

The optical member 8 includes a polarizing plate 9, a third pressure-sensitive adhesive layer 10, a concealing layer 11, and a transparent protective member 12.

The polarizing plate 9 has a generally flat plate shape extending in the plane direction. The polarizing plate 9 has the same outer shape as the pressure-sensitive adhesive layer-including transparent electrically conductive sheet 2 when viewed from the top. The polarizing plate 9 is disposed on one surface in the thickness direction of the pressure-sensitive adhesive layer-including transparent electrically conductive sheet 2. Specifically, the polarizing plate 9 is in contact with the entire one surface 62 of the second pressure-sensitive adhesive layer 6. The polarizing plate 9 pressure-sensitively adheres to the hard coat layer 4 and the transparent electrically conductive layer 5 through the second pressure-sensitive adhesive layer 6. The total light transmittance of the polarizing plate 9 is, for example, 30% or more, preferably 35% or more, more preferably 40% or more, and for example, 50% or less. A thickness of the polarizing plate 9 is, for example, 1 μm or more, and for example, 100 μm or less.

The third pressure-sensitive adhesive layer 10 has a generally flat plate shape extending in the plane direction. The third pressure-sensitive adhesive layer 10 is disposed on one surface in the thickness direction of the polarizing plate 9. The third pressure-sensitive adhesive layer 10 is in contact with the entire one surface in the thickness direction of the polarizing plate 9. A material, the tensile elastic modulus E, the shear storage elastic modulus G′, the total light transmittance, a thickness, and the like of the third pressure-sensitive adhesive layer 10 are the same as those of the first pressure-sensitive adhesive layer 3.

The concealing layer 11 is a layer that avoids the user from visually recognizing the routing wire 52 from one side in the thickness direction in the touch sensor 1. The concealing layer 11 is disposed on one surface in the thickness direction of the third pressure-sensitive adhesive layer 10 in the margin region 92. In short, in the touch sensor 1, when projected in the thickness direction, a region that is overlapped with the concealing layer 11 is the margin region 92, and a region that is not overlapped is the display region 91. One surface in the thickness direction of the concealing layer 11 is flush with one surface in the thickness direction of the third pressure-sensitive adhesive layer 10 in the display region 91. An example of a material for the concealing layer 11 includes a composition containing a black component and a resin. The total light transmittance of the concealing layer 11 is, for example, 10% or less, preferably 5% or less, and for example, 0.0001% or more. A thickness of the concealing layer 11 is, for example, 0.5 μm or more, and for example, 50 μm or less.

The transparent protective member 12 has a generally flat plate shape extending in the plane direction. The transparent protective member 12 is disposed on one surface in the thickness direction of the polarizing plate 9 and one surface in the thickness direction of the concealing layer 11. Specifically, the transparent protective member 12 is in contact with one surface in the thickness direction of the third pressure-sensitive adhesive layer 10 in the display region 91 and one surface in the thickness direction of the concealing layer 11 in the margin region 92. In the display region 91, the transparent protective member 12 pressure-sensitively adheres to the polarizing plate 9 through the third pressure-sensitive adhesive layer 10. A material for the transparent protective member 12 is not particularly limited as long as it has transparency and excellent mechanical strength, and examples thereof include glass and resins (for example, a polyimide resin, an acrylic resin, and the like). The total light transmittance of the transparent protective member 12 is, for example, 80% or more, preferably 85% or more, more preferably 90% or more, and for example, 100% or less. A thickness of the transparent protective member 12 is, for example, 10 μm or more, and for example, 200 μm or less.

A thickness of the optical member 8 is, for example, 50 μm or more, preferably 100 in or more, and for example, 300 μm or less, preferably 200 μm or less.

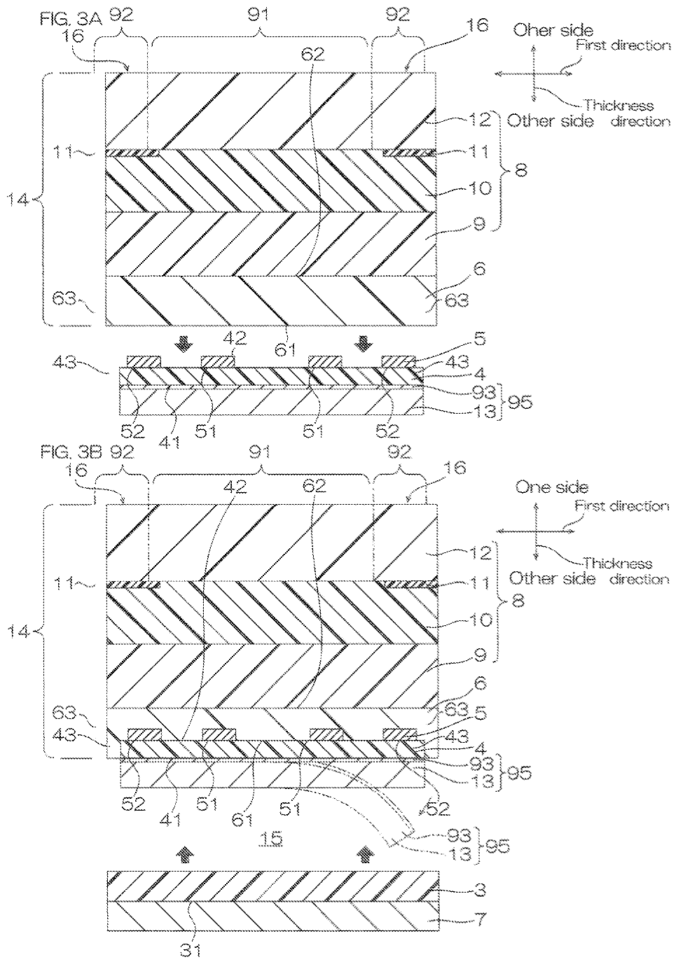

To obtain the touch sensor 1, as shown in FIG. 3A, first, a support peeling laminate 95 having a support substrate 13 and a third peeling layer 93 is prepared.

The support substrate 13 has a generally flat plate shape extending in the plane direction. Examples of a material for the support substrate 13 include a metal and a resin, and preferably, a resin is used, more preferably, a polyester resin (PET and the like) is used. A thickness of the support substrate 13 is, for example, 8 μm or more, preferably 50 μm or more, and for example, 500 μm or less, preferably 250 μm or less.

The third peeling layer 93 is disposed on one surface in the thickness direction of the support substrate 13. Specifically, the third peeling layer 93 is in contact with the entire one surface in the thickness direction of the support substrate 13. Examples of a material for the third peeling layer 93 include a fluororesin, a silicone resin, and an oil. A thickness of the third peeling layer 93 is, for example, 0.01 μm or more, preferably 0.5 μm or more, and for example, 10 μm or less, preferably 5 μm or less.

It is also possible to use the support substrate 13 whose surface is subjected to a peeling treatment instead of the support peeling laminate 95.

Then, for example, a transparent composition is applied (subjected to screen printing and the like) to one surface in the thickness direction of the support peeling laminate 95 (one surface in the thickness direction of the third peeling layer 93), thereby forming the hard coat layer 4. The hard coat layer 4 is in contact with the entire one surface in the thickness direction of the support peeling laminate 95. Next, the transparent electrically conductive layer 5 is formed on the one surface 42 of the hard coat layer 4 in a pattern having the transparent electrode 51 and the routing wire 52 by sputtering or etching.

Separately, an optical laminate 14 including the second pressure-sensitive adhesive layer 6 and the optical member 8 (the polarizing plate 9, the third pressure-sensitive adhesive layer 10, the concealing layer 11, and the transparent electrically conductive layer 5) is prepared. Preferably, the optical laminate 14 consists of the second pressure-sensitive adhesive layer 6 and the optical member 8. In the optical laminate 14, the other surface 61 of the second pressure-sensitive adhesive layer 6 is a flat surface parallel to the one surface 62.

Thereafter, if necessary, a terminal of a flexible wiring board which is not shown is electrically connected to an end portion of the routing wire 52.

Subsequently, as shown by arrows of FIG. 3A, and FIG. 3B, the second pressure-sensitive adhesive layer 6 of the optical laminate 14 is compressively bonded (pressure-sensitively adheres) to the transparent electrically conductive layer 5 and the hard coat layer 4 around it. Then, the other surface 61 of the second pressure-sensitive adhesive layer 6 follows the shape of the hard coat layer 4 and the transparent electrically conductive layer 5. Thus, a support substrate-including laminate 15 having the support peeling laminate 95, the hard coat layer 4, the transparent electrically conductive layer 5, and the optical laminate 14 (the second pressure-sensitive adhesive layer 6 and the optical member 8) is obtained.

Thereafter, as shown by the phantom line of FIG. 3B, the support peeling laminate 95 in the support substrate-including laminate 15 is peeled (pulled off) from the other surface 41 of the hard coat layer 4.

Thereafter, as shown by thick arrows of FIG. 3B, the first pressure-sensitive adhesive layer 3 in which the other surface 31 is supported by the peeling layer 7 is compressively bonded (pressure-sensitively adheres) to the other surface 41 of the hard coat layer 4 and the other surface 61 of the second pressure-sensitive adhesive layer 6 at both outer sides in the first direction of the hard coat layer 4.

Thus, the pressure-sensitive adhesive layer-including transparent electrically conductive sheet 2 shown in FIG. 2 is obtained.

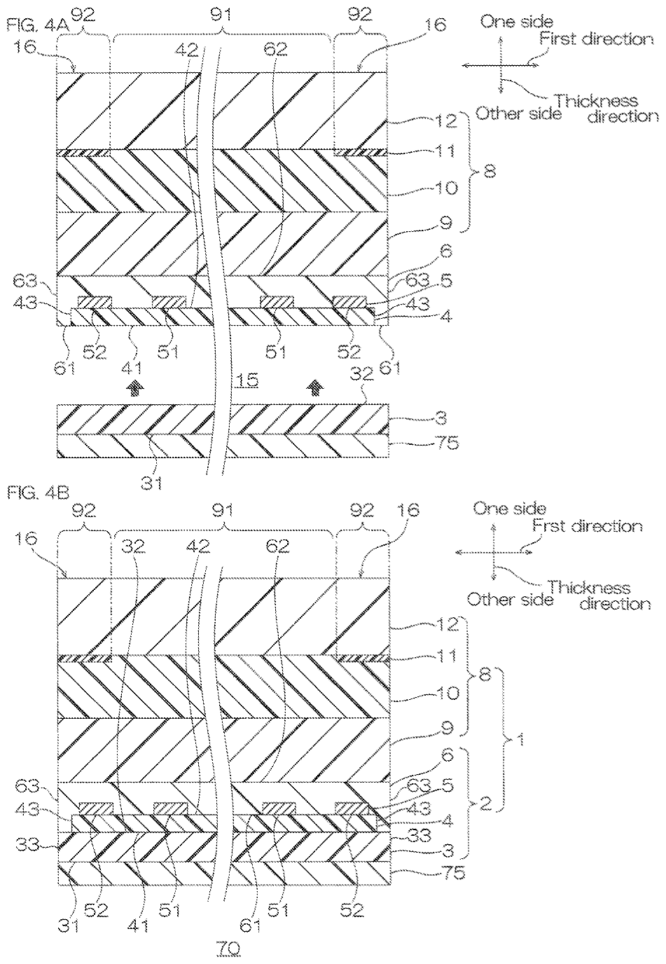

Next, an image display device including the touch sensor 1 is described with reference to FIGS. 4A to 4B.

As shown in FIG. 4B, an image display device 70 includes the touch sensor 1 and an image display member 75 in order toward the other side in the thickness direction. Preferably, the image display device 70 consists of the touch sensor 1 and the image display member 75.

The pressure-sensitive adhesive layer-including transparent electrically conductive sheet 2 in the image display device 70 does not include the peeling layer 7 (ref: FIG. 2), and consists of only the first pressure-sensitive adhesive layer 3, the hard coat layer 4, the transparent electrically conductive layer 5, and the second pressure-sensitive adhesive layer 6.

The image display member 75 is overlapped with at least the display region 91 in the touch sensor 1 when projected in the thickness direction. The image display member 75 is disposed on the other surface 31 of the first pressure-sensitive adhesive layer 3. Specifically, the image display member 75 is in contact with the entire other surface 31 of the first pressure-sensitive adhesive layer 3. The image display member 75 pressure-sensitively adheres to the hard coat layer 4 through the first pressure-sensitive adhesive layer 3. The image display member 75 has a generally flat plate shape extending in the plane direction. Examples of the image display member 75 include an organic EL (electroluminescence) display device (OLED) and a liquid crystal display device (LCD). A thickness of the image display member 75 is, for example, 1 μm or more, and for example, 100 μm or less.

To produce the image display device 70, as shown by a solid line of FIG. 3B, the support substrate-including laminate 15 is fabricated, and subsequently, as shown by the phantom line of FIG. 3B, the support peeling laminate 95 is peeled from the other surface 41 of the hard coat layer 4 of the support substrate-including laminate 15. Thus, as shown in FIG. 4A, the other surface 41 of the hard coat layer 4 is exposed toward the other side in the thickness direction.

Thereafter, the image display member 75 is compressively bonded (pressure-sensitively adheres, is attached) to the other surface 41 of the hard coat layer 4 and the other surface 61 of the second pressure-sensitive adhesive layer 6 at both outer sides in the first direction of the hard coat layer 4 through the first pressure-sensitive adhesive layer 3. In other words, the image display member 75 is brought into contact with the other surface 31 of the first pressure-sensitive adhesive layer 3.

Thus, the image display device 70 including the image display member 75 and the touch sensor 1 is obtained.

### Function and Effect of One Embodiment

In the pressure-sensitive adhesive layer-including transparent electrically conductive sheet 2, as shown in FIG. 2, in the first direction, each of both edge surfaces 43 of the hard coat layer 4 is disposed inside with respect to each of both edge surfaces 33 of the first pressure-sensitive adhesive layer 3, and is disposed inside with respect to each of both edge surfaces 63 of the second pressure-sensitive adhesive layer 6.

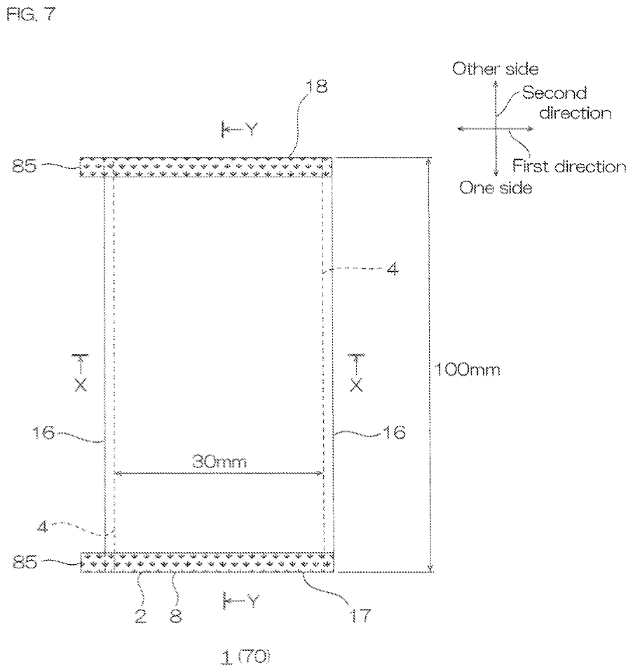

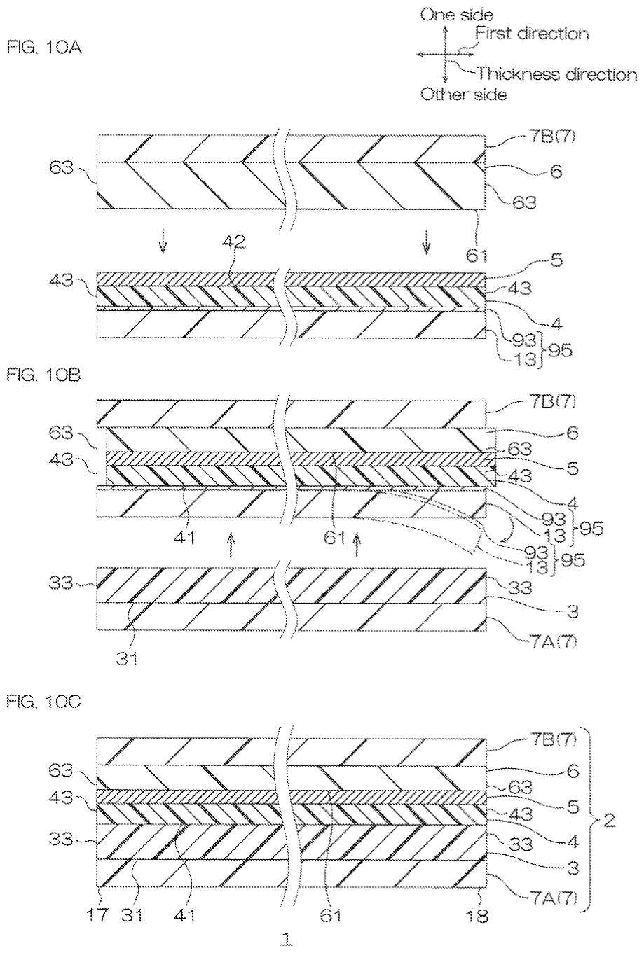

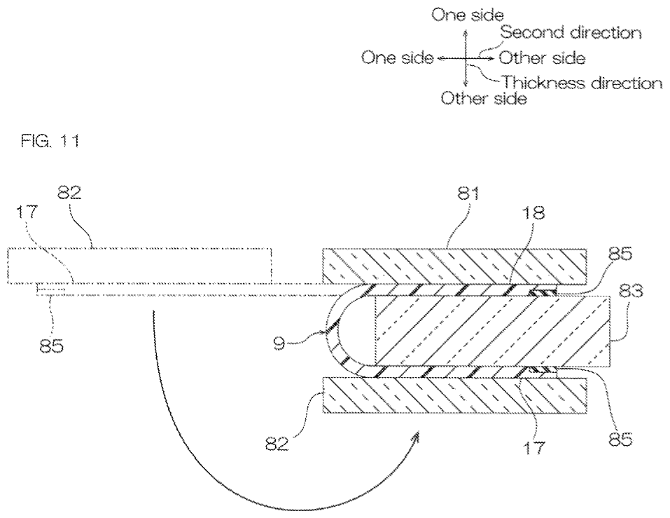

However, as in Comparative Example 1 shown in FIG. 10C, in the first direction, when each of both edge surfaces 43 of the hard coat layer 4 coincides with each of both edge surfaces 33 of the first pressure-sensitive adhesive layer 3, as shown in FIG. 11, the stress is concentrated on both edge surfaces 43 of the hard coat layer 4 when the touch sensor t including the pressure-sensitive adhesive layer-including transparent electrically conductive sheet 2 is deflected or bent (when bent so as to form a fold (to be specific, a fold along an X-X line in FIG. 7) along the first direction of the touch sensor 1) so that the first end portion 17 and the second end portion 18 get close to each other. Then, the stress described above can be alleviated in a portion overlapped with both edge surfaces 43 of the hard coat layer 4 in the thickness direction and an inner-side vicinity portion disposed slightly inside in the first direction from the overlapped portion in the first pressure-sensitive adhesive layer 3 and the second pressure-sensitive adhesive layer 6, and there is a limit thereto.

However, in one embodiment, as shown in FIG. 2, in addition to the overlapped portion and the inner-side vicinity portion described above, an outer-side vicinity portion (the first pressure-sensitive adhesive layer 3 and the second pressure-sensitive adhesive layer 6 located outside both edge surfaces 43 of the hard coat layer 4) cooperates, and it is possible to sufficiently alleviate the stress applied to both edge surfaces 43 of the hard coat layer 4. Therefore, it is possible to suppress damage to both edge surfaces 43 of the hard coat layer 4.

Since the pressure-sensitive adhesive layer-including transparent electrically conductive sheet 2 is bendable, it has excellent handleability. Moreover, since the pressure-sensitive adhesive layer-including transparent electrically conductive sheet 2 is bendable so that both edge surfaces in the second direction get close to each other, even when the pressure-sensitive adhesive layer-including transparent electrically conductive sheet 2 is bent so that the first end portion 17 and the second end portion 18 in the second direction get close to each other, the first pressure-sensitive adhesive layer 3 and the second pressure-sensitive adhesive layer 6 near the outside of both edge surfaces 43 of the hard coat layer 4 can disperse the stress. Therefore, the pressure-sensitive adhesive layer-including transparent electrically conductive sheet 2 has excellent handleability and excellent reliability.

### MODIFIED EXAMPLES

In the following modified examples, the same reference numerals are provided for members and steps corresponding to each of those in the above-described one embodiment, and their detailed description is omitted. Further, each of the modified examples can achieve the same function and effect as that of one embodiment unless otherwise specified. Furthermore, one embodiment and the modified examples can be appropriately used in combination.

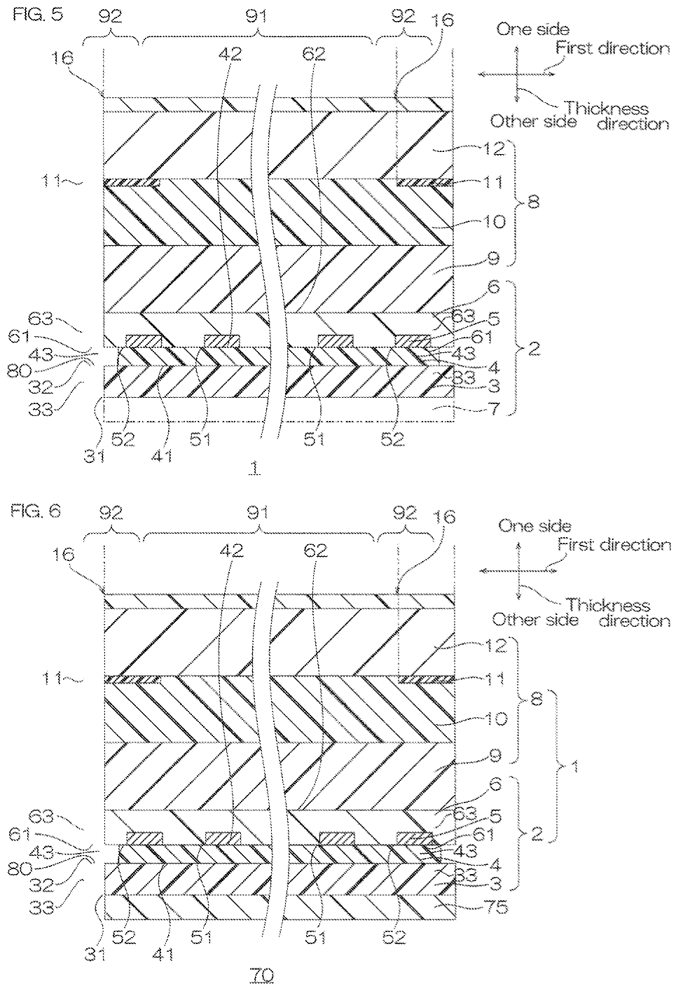

In both of the pressure-sensitive adhesive layer-including transparent electrically conductive sheet 2 in the touch sensor 1 shown in FIG. 5 and the pressure-sensitive adhesive layer-including transparent electrically conductive sheet 2 in the image display device 70 shown in FIG. 6, both edge surfaces 43 of the hard coat layer 4 are exposed from the first pressure-sensitive adhesive layer 3 and the second pressure-sensitive adhesive layer 6 toward both outer sides in the first direction. In other words, a recessed portion 80 leading to the outside is formed by both edge surfaces 43 of the hard coat layer 4, the one surfaces 32 of both end portions 16 in the first pressure-sensitive adhesive layer 3, and the other surfaces 63 of both end portions 16 in the second pressure-sensitive adhesive layer 6. The recessed portion 80 is recessed inwardly from both edge surfaces 33 of the first pressure-sensitive adhesive layer 3 and both edge surfaces 63 of the second pressure-sensitive adhesive layer 6 in the first direction.

Preferably, as in the pressure-sensitive adhesive layer-including transparent electrically conductive sheet 2 shown in FIG. 2 and the image display device 70 shown in FIG. 4B, the other surface 61 of the second pressure-sensitive adhesive layer 6 is in contact with both edge surfaces 43 of the hard coat layer 4 in the first direction. With this configuration, the second pressure-sensitive adhesive layer 6 in contact with both edge surfaces 43 of the hard coat layer 4 can sufficiently alleviate the stress applied to both edge surfaces 43 of the hard coat layer 4. Therefore, it is possible to effectively suppress damage to both edge surfaces 43 of the hard coat layer 4.

The pressure-sensitive adhesive layer-including transparent electrically conductive sheet 2 is provided in the touch sensor 1 and the image display member 75. Alternatively, for example, though not shown, another peeling layer (not shown) is disposed on the one surface 62 of the second pressure-sensitive adhesive layer 6 and it can be used alone as the pressure-sensitive adhesive layer-including transparent electrically conductive sheet 2. That is, the pressure-sensitive adhesive layer-including transparent electrically conductive sheet 2 is an industrially available device which can be used alone.

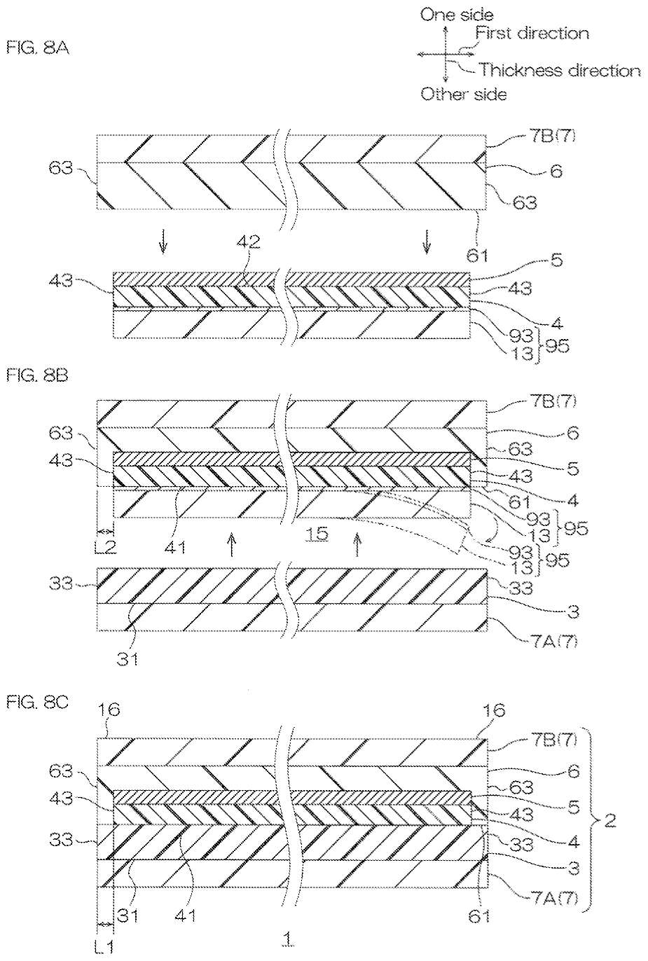

In another modified example, as shown in FIG. 8C, the transparent electrically conductive layer 5 may be disposed on the entre one surface 42 of the hard coat layer 4 without having a pattern of the transparent electrode 51 and the routing wire 52.

### EXAMPLES

Next, the present invention is further described based on Preparation Examples, Examples, and Comparative Example shown below. The present invention is however not limited by these Examples and Comparative Examples. The specific numerical values in mixing ratio (ratio), property value, and parameter used in the following description can be replaced with upper limit values (numerical values defined as “or less” or “below”) or lower limit values (numerical values defined as “or more” or “above”) of corresponding numerical values in mixing ratio (ratio), property value, and parameter described in the above-described “DESCRIPTION OF EMBODIMENTS”.

[Preparation of Pressure-Sensitive Adhesive Sheet]

Each of the following pressure-sensitive adhesive sheets A to C was prepared.

[Pressure-Sensitive Adhesive Sheet A]

A four-necked flask equipped with a stirring blade, a thermometer, a nitrogen gas introduction pipe, and a condenser was charged with 99 parts by mass of a butyl acrylate (BA) and 1 part by mass of a 4-hydroxybutyl acrylate (HBA), thereby preparing a monomer mixture.

Furthermore, together with an ethyl acetate, 0.1 parts by mass of a 2,2′-azobisisobutyronitrile was charged with respect to 100 parts by mass of the monomer mixture, a nitrogen gas was introduced with gentle stirring to be replaced with nitrogen, and then, the mixture was subjected to a polymerization reaction for seven hours, while the liquid temperature in a flask was kept at around 55° C., thereby obtaining a reaction solution. Thereafter, an ethyl acetate was added to the reaction solution to adjust the solid content concentration at 30%. Thus, a solution of an acrylic base polymer having a weight average molecular weight of 1.6 million was prepared.

By blending 0.1 parts by mass of an isocyanate-based cross-linking agent (trade name: TAKENATE D110N, trimethylolpropane modified product of xylylene diisocyanate, manufactured by Mitsui Chemicals, Inc.), 0.3 parts by mass of a benzoyl peroxide (trade name: NYPER BMT, manufactured by NOF CORPORATION), and 0.08 parts by mass of a silane coupling agent (trade name: KBM403, manufactured by Shin-Etsu Chemical Co., Ltd.) with respect to 100 parts by mass of a solid content of the solution of the acrylic base polymer, an acrylic pressure-sensitive adhesive composition was prepared.

The acrylic pressure-sensitive adhesive composition was uniformly applied to the surface of a peeling sheet (the peeling layer 7) made of a PET film with a fountain coater and dried in an air circulation-type constant temperature oven at 155° C. for two minutes. Thus, a pressure-sensitive adhesive sheet A whose material was an acrylic pressure-sensitive adhesive was prepared.

[Pressure-Sensitive Adhesive Sheet B]

A four-necked flask equipped with a stirring blade, a thermometer, a nitrogen gas introduction pipe, and a condenser was charged with 99 parts by mass of a butyl acrylate (BA) and 1 part by mass of a 4-hydroxybutyl acrylate (iBA), thereby preparing a monomer mixture.

Furthermore, together with an ethyl acetate, 0.1 parts by mass of a 2,2′-azobisisobutyronitrile was charged with respect to 100 parts by mass of the monomer mixture, a nitrogen gas was introduced with gentle stirring to be replaced with nitrogen, and then, the mixture was subjected to a polymerization reaction for seven hours, while the liquid temperature in a flask was kept at around 55° C., thereby obtaining a reaction solution. Thereafter, a mixed solvent of an ethyl acetate and a toluene (mass ratio of 95/5) was added to the reaction solution to adjust the solid content concentration at 30%. Thus, a solution of an acrylic base polymer having a weight average molecular weight of 1.6 million was prepared.

By blending 0.15 parts by mass of an isocyanate-based cross-linking agent (trimethylolpropane modified product of tolylene diisocyanate, manufactured by Nippon Polyurethane Industry Co., Ltd., trade name: Coronate L) and 0.08 parts by mass of a silane coupling agent (trade name: KBM403, manufactured by Shin-Etsu Chemical Co., Ltd.) with respect to 100 parts by mass of a solid content of the solution of the acrylic base polymer, an acrylic pressure-sensitive adhesive composition was prepared.

The acrylic pressure-sensitive adhesive composition was uniformly applied to the surface of a peeling sheet (the peeling layer 7) made of a PET film with a fountain coater and dried in an air circulation-type constant temperature oven at 155° C. for two minutes. Thus, a pressure-sensitive adhesive sheet B whose material was an acrylic pressure-sensitive adhesive was prepared.

[Pressure-Sensitive Adhesive Sheet C]

A four-necked flask equipped with a stirring blade, a thermometer, a nitrogen gas introduction pipe, and a condenser was charged with 63 parts by mass of a 2-ethylhexyl acrylate (2EHA), 15 parts by mass of an N-vinyl-2-pyrrolidone (NVP), 9 parts by mass of a methyl methacrylate (MMA), 13 parts by mass of a 2-hydroxyethyl acrylate (HEA), 0.2 parts by mass of a 2,2′-azobisisobutyronitrile, and 133 parts by mass of an ethyl acetate, and the mixture was stirred for one hour, while a nitrogen gas was introduced. After removing oxygen in the polymerization system in this manner, the temperature was increased to 65° C., the mixture was reacted for 10 hours, and then, an ethyl acetate was added to obtain an acrylic polymer solution having a solid content concentration of 30% by weight. A weight average molecular weight of the acrylic polymer in the acrylic polymer solution was 0.8 million.

Then, with respect to 100 parts by mass of an acrylic polymer (solid content), an isocyanate-based cross-linking agent (trade name “TAKENATE D110N”, trimethylolpropane modified product of xylylene diisocyanate, manufactured by Mitsui Chemicals, Inc.) was added and mixed to form 1.1 parts by mass in terms of solid content, so that an acrylic pressure-sensitive adhesive composition was prepared.

The acrylic pressure-sensitive adhesive composition was uniformly applied to the surface of a peeling sheet (the peeling layer 7) made of a PET film with a fountain coater and dried in an air circulation-type constant temperature oven at 130° C. for three minutes. Thus, a pressure-sensitive adhesive sheet C whose material was an acrylic pressure-sensitive adhesive was prepared.

[Production of Pressure-Sensitive Adhesive Layer-Including Transparent Electrically Conductive Sheet]

### Example 1

The pressure-sensitive adhesive layer-including transparent electrically conductive sheet 2 shown in FIGS. 7 to 9C was produced. The pressure-sensitive adhesive layer-including transparent electrically conductive sheet 2 of Example 1 corresponds to one embodiment.

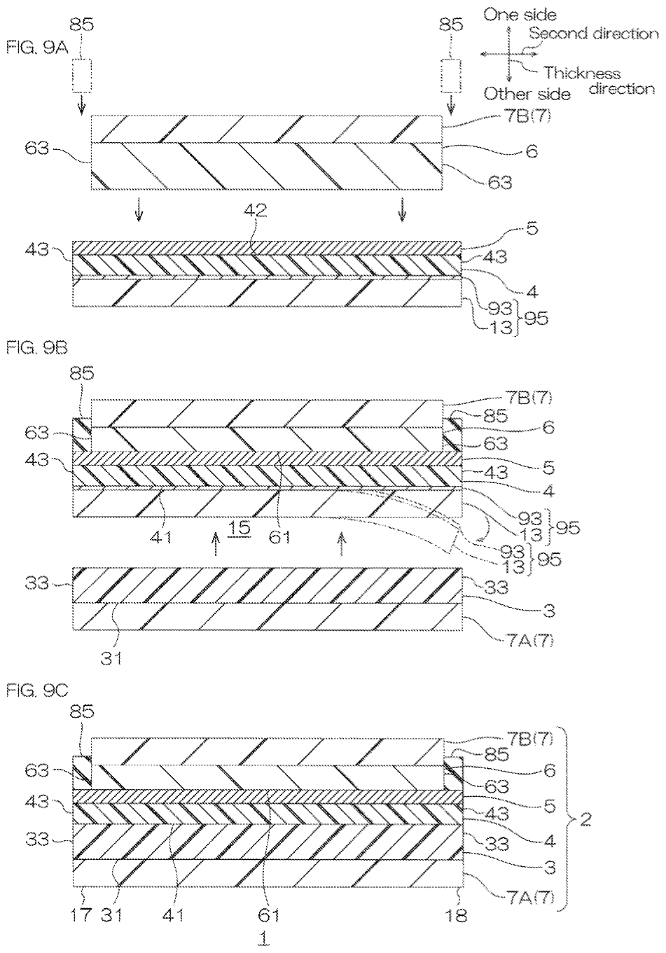

As shown in FIGS. 8A and 9A, first, a hard coat composition described in Example 2 of Japanese Unexamined Patent Publication No. 2019-31041 was applied to one surface in the thickness direction of the support substrate 13 (corresponding to the support peeling laminate 95) whose one surface in the thickness direction was subjected to a peeling treatment and made of PET, thereby forming the hard coat layer 4 having a thickness of 5 μm. Then, the transparent electrically conductive layer 5 made of ITO and having a thickness of 50 nm was formed on the entire one surface 42 of the hard coat layer 4 by sputtering.

As shown in FIGS. 8B and 9B, the second pressure-sensitive adhesive layer 6 supported by a second peeling layer 7B (peeling sheet), made of the pressure-sensitive adhesive sheet B, and having a thickness of 25 μm was compressively bonded to the transparent electrically conductive layer 5 and the hard coat layer 4. As shown in FIG. 9A, the second pressure-sensitive adhesive layer 6 covered both edge surfaces in the first direction of the transparent electrically conductive layer 5 and both edge surfaces 43 of the hard coat layer 4. As shown in FIG. 9B, the second pressure-sensitive adhesive layer 6 was in contact with the inside of both end portions in the second direction of the transparent electrically conductive layer 5. The second pressure-sensitive adhesive layer 6 was not in contact with both end portions in the second direction of the transparent electrically conductive layer 5. Thus, the support substrate-including laminate 15 having the support substrate 13, the hard coat layer 4, the transparent electrically conductive layer 5, the second pressure-sensitive adhesive layer 6, and the second peeling layer 7B was obtained. The distance 12 between each of both edge surfaces 63 in the first direction of the second pressure-sensitive adhesive layer 6 and each of both edge surfaces 43 in the first direction of the hard coat layer 4 was 0.5 mm.

Thereafter, as shown by the phantom line of FIG. 8B and the phantom line of FIG. 9B, the support substrate 13 in the support substrate-including laminate 15 was peeled.

Thereafter, as shown in FIGS. 8C and 9C, the first pressure-sensitive adhesive layer 3 supported by a first peeling layer 7A (peeling sheet), made of the pressure-sensitive adhesive sheet B, and having a thickness of 25 μm was compressively bonded to the other surface 41 of the hard coat layer 4 and the other surface 61 of the second pressure-sensitive adhesive layer 6. The distance L1 between each of both edge surfaces 43 in the first direction of the hard coat layer 4 and each of both edge surfaces 33 in the first direction of the first pressure-sensitive adhesive layer 3 was 0.5 mm.

### Example 2 to Comparative Example 1

The pressure-sensitive adhesive layer-including transparent electrically conductive sheet 2 was obtained in the same manner as in Example 1, except that the thickness of the hard coat layer 4, the kind or the thickness of the first pressure-sensitive adhesive layer 3 and the second pressure-sensitive adhesive layer 5, and the distance L1 and the distance L2 were changed to those shown in Table 1.

Above all, in Comparative Example 1, as shown in FIG. 10C, each of both edge surfaces 43 in the first direction of the hard coat layer 4 coincided with each of both edge surfaces 33 in the first direction of the first pressure-sensitive adhesive layer 3 and each of both edge surfaces 43 in the first direction of the second pressure-sensitive adhesive layer 6.

Specifically, in Comparative Example 1, as shown in FIG. 10C, the first pressure-sensitive adhesive layer 3 was compressively bonded to the other surface 41 of the hard coat layer 4 so as not to be in contact with the second pressure-sensitive adhesive layer 6.

[Tensile Elastic Modulus E]

Each of the tensile elastic modulus E of the first pressure-sensitive adhesive layer 3 and the second pressure-sensitive adhesive layer 6 was determined as follows.

The first pressure-sensitive adhesive layer 3 was laminated so as to have a thickness of 100 μm to adjust the thickness of the first pressure-sensitive adhesive layer 3. The first pressure-sensitive adhesive layer 3 was trimmed to have a width of 10 mm and a length of 100 mm. The first pressure-sensitive adhesive layer 3 was set in a tensile testing machine (manufactured by Shimadzu Corporation, trade name “Autograph AG-IS”), and the tensile elastic modulus E of the first pressure-sensitive adhesive layer 3 was calculated from an inclination of the curve with the strain in a range of 0.05% to 0.25% by measuring the strain and the stress when pulled at 200 mm/min.

The tensile elastic modulus E of the second pressure-sensitive adhesive layer 6 was calculated in the same manner as the description above.

[Shear Storage Elastic Modulus G′]

The shear storage elastic modulus G′ at 25° C. of each of the pressure-sensitive adhesive sheets A to C was measured.

Specifically, the pressure-sensitive adhesive sheet was trimmed in a disk shape and sandwiched between parallel plates, and the shear storage elastic modulus G′ of the pressure-sensitive adhesive sheet was determined using the “Advanced Rheometric Expansion System (ARES)” manufactured by Rheometric Scientific by the dynamic viscoelasticity measurement under the following conditions. The results are shown in Table 1.

<Measurement Conditions>

Mode: Torsion

Temperature: −40° to 150° C.

Temperature rising rate: 5° C./min

Frequency: 1 Hz

[Evaluation]

During the production process of each of the pressure-sensitive adhesive layer-including transparent electrically conductive sheets 2 of Examples and Comparative Example, as shown by the arrows of FIG. 9A, and FIG. 9B, an electrically conductive tape 85 was attached to both end portions in the second direction of the transparent electrically conductive layer 5 to which the second pressure-sensitive adhesive layer 6 was compressively bonded. As shown in FIG. 7, the electrically conductive tape 85 was attached to both end portions in the second direction exposed from the second pressure-sensitive adhesive layer 6 in the transparent electrically conductive layer 5. Each one end portion in the first direction of the two electrically conductive tapes 85 was protruded from the support substrate 13 toward one side in the first direction. Subsequently, as shown by the arrows of FIG. 8B and the arrows of FIG. 9B, the support substrate 13 was peeled from the hard coat layer 4. Thereafter, as shown in FIGS. 8C and 9C, the first pressure-sensitive adhesive layer 3 was attached to the other surface 41 of the hard coat layer 4. Thus, the pressure-sensitive adhesive layer-including transparent electrically conductive sheet 2 was obtained.

Thereafter, as shown in FIG. 11, the pressure-sensitive adhesive layer-including transparent electrically conductive sheet 2 was bent at 180 degrees. At this time, the first end portion 17 and the second end portion 18 got close to each other. The two electrically conductive tapes 85 faced each other. Further, the outside of the pressure-sensitive adhesive layer-including transparent electrically conductive sheet 2 that was bent was pressed by two glass plates 81 and 82, and furthermore, a spacer 83 made of a glass plate and having a thickness of 2 mm was inserted between the two electrically conductive tapes 85. This kept the interval between the two electrically conductive tapes 85 at 2 mm.

By using a tester, the resistance of the transparent electrically conductive layer 5 before and after bending was measured. The resistance of the transparent electrically conductive layer 5 between the two electrically conductive tapes 85 before bending was determined. A case of the hard coat layer 4 of the pressure-sensitive adhesive layer-including transparent electrically conductive sheet 2 having the resistance in a bent state 1.1 times or more of the resistance before bending was evaluated as occurrence of a crack. In Table, the case was shown as “Bad”. On the other hand, a case of the hard coat layer 4 of the pressure-sensitive adhesive layer-including transparent electrically conductive sheet 2 having the resistance in a bent state below 1.1 times of the resistance before bending was evaluated as no occurrence of a crack. In Table, the case was shown as “Excellent”.

TABLE 1

| | | First Pressure-Sensitive Adhesive Layer | | | | Second Pressure-Sensitive Adhesive Layer | | | | | | Evalu- |
|---|---|---|---|---|---|---|---|---|---|---|---|---|
| | Hard | | Shear | | | | Shear | | | | | ation |
| | Coat | | Storage | Tensile | | | Storage | Tensile | | | | Damage |
| Examples/ | Layer | Pressure- | Elastic | Elastic | | Pressure- | Elastic | Elastic | | | | to |
| Compar- | Thick- | Sensitive | Modulus | Modulus | Thick- | Sensitive | Modulus | Modulus | Thick- | Distance | | Hard |
| ative | ness | Adhesive | G′ | E | ness | Adhesive | G′ | E | ness | L1 | L2 | Coat |
| Example | [μm] | Sheet | [MPa] | [MPa] | [μm] | Sheet | [MPa] | [MPa] | [μm] | [mm] | [mm] | Layer |
| Example 1 | 5 | Pressure- | 0.11 | 0.40 | 25 | Pressure- | 0.11 | 0.40 | 25 | 0.3 | 0.3 | Excellent |
| | | Sensitive | | | | sensitive | | | | | | |
| | | Adhesive | | | | Adhesive | | | | | | |
| | | Sheet B | | | | Sheet B | | | | | | |
| Example 2 | 3 | Pressure- | 0.11 | 0.40 | 25 | Pressure- | 0.11 | 0.40 | 25 | 0.3 | 0.3 | Excellent |
| | | Sensitive | | | | Sensitive | | | | | | |
| | | Adhesive | | | | Adhesive | | | | | | |
| | | Sheet B | | | | Sheet B | | | | | | |
| Example 3 | 5 | Pressure- | 0.08 | 0.21 | 25 | Pressure- | 0.08 | 0.21 | 25 | 0.3 | 0.3 | Excellent |
| | | Sensitive | | | | Sensitive | | | | | | |
| | | Adhesive | | | | Adhesive | | | | | | |
| | | Sheet A | | | | Sheet A | | | | | | |
| Example 4 | 5 | Pressure- | 0.28 | 0.62 | 25 | Pressure- | 0.23 | 0.62 | 25 | 0.3 | 0.3 | Excellent |
| | | Sensitive | | | | Sensitive | | | | | | |
| | | Adhesive | | | | Adhesive | | | | | | |
| | | Sheet C | | | | Sheet C | | | | | | |
| Example 5 | 5 | Pressure- | 0.11 | 0.40 | 15 | Pressure- | 0.11 | 0.40 | 15 | 0.3 | 0.3 | Excellent |
| | | Sensitive | | | | Sensitive | | | | | | |
| | | Adhesive | | | | Adhesive | | | | | | |
| | | Sheet B | | | | Sheet B | | | | | | |
| Example 6 | 5 | Pressure- | 0.11 | 0.40 | 25 | Pressure- | 0.11 | 0.40 | 25 | 0.5 | 0.5 | Excellent |
| | | Sensitive | | | | Sensitive | | | | | | |
| | | Adhesive | | | | Adhesive | | | | | | |
| | | Sheet B | | | | Sheet B | | | | | | |
| Compar- | 5 | Pressure- | 0.11 | 0.40 | 25 | Pressure- | 0.11 | 0.40 | 25 | 0 | 0 | Bad |
| ative | | Sensitive | | | | Sensitive | | | | | | |
| Example 1 | | Adhesive | | | | Adhesive | | | | | | |
| | | Sheet B | | | | Sheet B | | | | | | |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The pressure-sensitive adhesive layer-including transparent electrically conductive sheet of the present invention is used for production of a touch sensor and an image display device.

### DESCRIPTION OF REFERENCE NUMBER

1 Touch sensor
2 Pressure-sensitive adhesive layer-including transparent electrically conductive sheet
3 First pressure-sensitive adhesive layer
4 Hard coat layer
6 Second pressure-sensitive adhesive layer
8 Optical member
17 First end portion
18 Second end portion
32 One surface (first pressure-sensitive adhesive layer)
33 Both edge surfaces (first pressure-sensitive adhesive layer)
42 One surface (hard coat layer)
43 Both edge surfaces (hard coat layer)
63 Both edge surfaces (second pressure-sensitive adhesive layer)
70 Image display device

1. A pressure-sensitive adhesive layer-including transparent electrically conductive sheet comprising:
a first pressure-sensitive adhesive layer,
a hard coat layer disposed on one surface in a thickness direction of the first pressure-sensitive adhesive layer,
a transparent electrically conductive layer disposed on one surface in the thickness direction of the hard coat layer, and
a second pressure-sensitive adhesive layer disposed on one surface in the thickness direction of the hard coat layer so as to cover the transparent electrically conductive layer, wherein
in a first direction perpendicular to the thickness direction, each of both edge surfaces of the hard coat layer is disposed inside with respect to each of both edge surfaces of the first pressure-sensitive adhesive layer, and is disposed inside with respect to each of both edge surfaces of the second pressure-sensitive adhesive layer.

2. The pressure-sensitive adhesive layer-including transparent electrically conductive sheet according to claim 1, wherein
the second pressure-sensitive adhesive layer is in contact with both edge surfaces of the hard coat layer in the first direction.

3. The pressure-sensitive adhesive layer-including transparent electrically conductive sheet according to claim 1, wherein
the pressure-sensitive adhesive layer-including transparent electrically conductive sheet is bendable so that both end portions in a second direction perpendicular to the first direction and the thickness direction get close to each other.

4. The pressure-sensitive adhesive layer-including transparent electrically conductive sheet according to claim 2, wherein the pressure-sensitive adhesive layer-including transparent electrically conductive sheet is bendable so that both end portions in a second direction perpendicular to the first direction and the thickness direction get close to each other.

5. A touch sensor comprising:
the pressure-sensitive adhesive layer-including transparent electrically conductive sheet according to claim 1 and
an optical member disposed on one surface in a thickness direction of the pressure-sensitive adhesive layer-including transparent electrically conductive sheet.

6. A touch sensor comprising:
the pressure-sensitive adhesive layer-including transparent electrically conductive sheet according to claim 2 and
an optical member disposed on one surface in a thickness direction of the pressure-sensitive adhesive layer-including transparent electrically conductive sheet.

7. A touch sensor comprising:
the pressure-sensitive adhesive layer-including transparent electrically conductive sheet according to claim 3 and
an optical member disposed on one surface in a thickness direction of the pressure-sensitive adhesive layer-including transparent electrically conductive sheet.

8. An image display device comprising:
the touch sensor according to claim 5 and
an image display member disposed on the other surface in a thickness direction of the touch sensor.

9. An image display device comprising:
the touch sensor according to claim 6 and
an image display member disposed on the other surface in a thickness direction of the touch sensor.

10. An image display device comprising:
the touch sensor according to claim 7 and
an image display member disposed on the other surface in a thickness direction of the touch sensor.
